(19) United States
(12) Patent Application Publication
(10) Pub. No.: US 2015/0019393 A1
(43) Pub. Date: Jan. 15, 2015

(54) INFORMATION PROCESSING APPARATUS AND METHOD, AND NON-TRANSITORY COMPUTER READABLE MEDIUM

(71) Applicant: Fuji Xerox Co., Ltd., Tokyo (JP)

(72) Inventors: Toru MURAI, Kanagawa (JP); Hiroyuki HASEGAWA, Kanagawa (JP); Noriaki TANAKA, Kanagawa (JP)

(73) Assignee: FUJI XEROX CO., LTD., Tokyo (JP)

(21) Appl. No.: 14/257,477

(22) Filed: Apr. 21, 2014

(30) Foreign Application Priority Data
Jul. 10, 2013 (JP) 2013-144349

(51) Int. Cl. H04L 12/14

(52) U.S. Cl. CPC H04L 12/1471
USPC 705/34

(57) ABSTRACT

An information processing apparatus includes an obtaining unit, a calculator, and an output unit. The obtaining unit obtains fee information indicating a fee of a service used by multiple users. The calculator calculates a distributed price to be charged to each of the multiple users if the fee indicated by the fee information obtained by the obtaining unit is distributed among the multiple users. The output unit outputs data indicating distributed prices calculated by the calculator and items of identification information for identifying the multiple users to which the distributed prices are charged.

### CROSS-REFERENCE TO RELATED APPLICATIONS

This application is based on and claims priority under 35 USC 119 from Japanese Patent Application No. 2013-144349 filed Jul. 10, 2013.

### BACKGROUND

### Technical Field

The present invention relates to an information processing apparatus and method, and a non-transitory computer readable medium.

### SUMMARY

According to an aspect of the invention, there is provided an information processing apparatus including an obtaining unit, a calculator, and an output unit. The obtaining unit obtains fee information indicating a fee of a service used by multiple users. The calculator calculates a distributed price to be charged to each of the multiple users if the fee indicated by the fee information obtained by the obtaining unit is distributed among the multiple users. The output unit outputs data indicating distributed prices calculated by the calculator and items of identification information for identifying the multiple users to which the distributed prices are charged.

### BRIEF DESCRIPTION OF THE DRAWINGS

Exemplary embodiments of the present invention will be described in detail based on the following figures, wherein:

FIG. 1 illustrates an example of the overall configuration of an information processing system according to a first exemplary embodiment;

FIG. 2 illustrates an example of the hardware configuration of an information processing apparatus;

FIG. 3 illustrates an example of the functional configuration of an information processing apparatus;

FIG. 4 is a table for explaining a method for selecting identification information;

FIG. 5 is a graph for explaining a billing plan;

FIG. 6 is a sequence diagram illustrating examples of operations performed by an output unit, an information processing apparatus, and a service server device when performing distributed billing processing;

FIG. 7 illustrates an example of displayed selection results and calculation results;

FIG. 8 illustrates an example of the functional configuration of an information processing apparatus according to a second exemplary embodiment;

FIGS. 9A through 9D are diagrams illustrating examples of correlation data;

FIG. 10 illustrates an example of a distribution ratio table;

FIG. 11 illustrates an example of a selection image;

FIG. 12 illustrates an example of displayed distributed prices;

FIG. 13 is a sequence diagram illustrating examples of operations performed by output units, an information processing apparatus, and a service server device when performing distributed billing processing in the second exemplary embodiment; and

FIG. 14 illustrates an example of distributed prices displayed on an output device.

### DETAILED DESCRIPTION

### [1] First Exemplary Embodiment

### [1-1] Overall Configuration

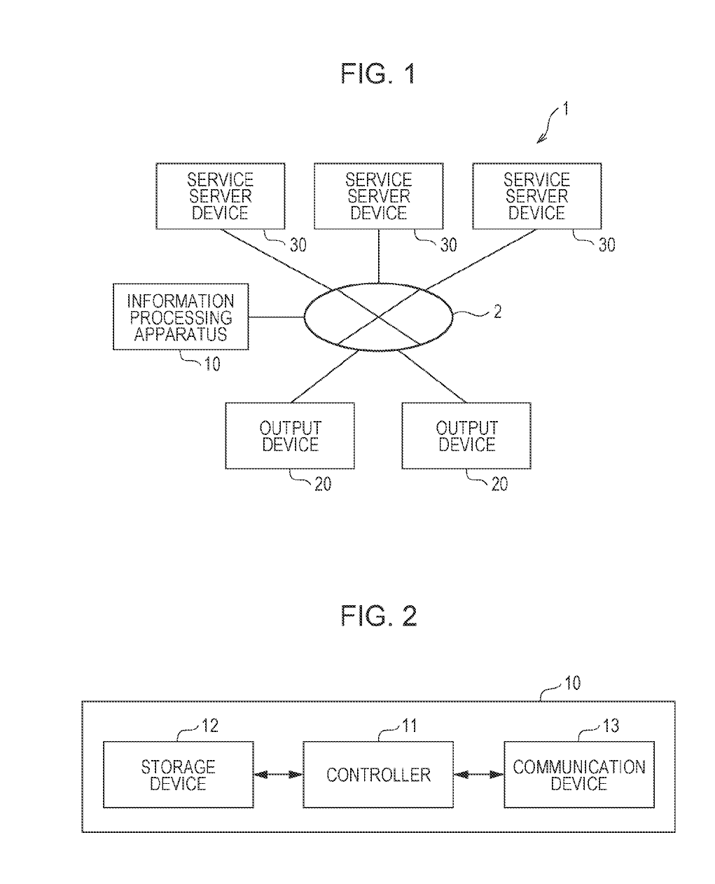

FIG. 1 illustrates an example of the overall configuration of an information processing system 1 according to a first exemplary embodiment. The information processing system 1 includes, as shown in FIG. 1, a network 2, an information processing apparatus 10, plural output devices 20, and plural service server devices 30. The network 2 is a system which includes the Internet, a mobile communication network, and so on, and performs communication. The network 2 causes devices connected to the system of the network 2 or devices which perform wireless communication with the system of the network 2 to exchange data. In the example shown in FIG. 1, the information processing apparatus 10, the plural output devices 20, and the plural service server devices 30 are connected to the network 2.

In the information processing system 1, the information processing apparatus 10, the plural output devices 20, and the plural service server devices 30 exchange data therebetween, thereby providing services which are not free (hereinafter referred to as “charged services”) to users. Examples of charged services are difference extraction services for extracting a difference between two items of data, music score providing services for providing music scores, music score arranging services for arranging music scores, data conversion services for converting data formats, OCR (Optical Character Recognition) services, and translation services. When a user uses a charged service, a fee for this charged service (hereinafter also called a “service fee”) is charged to the user. In the information processing system 1, in particular, the following distributed billing services are provided. When multiples users use a charged service, a service fee is distributed among the multiple users, and then, a distributed fee is charged to each user.

To provide charged services, such as difference extraction services and translation services, the plural service server devices 30 perform difference extraction processing and translation processing (hereinafter referred to as “service processing”). These charged services are provided in the form of so-called “cloud services”. Accordingly, service processing is not necessarily performed by a single specific device. For simple representation, however, in the example shown in FIG. 1, a description will be given, assuming that a single service server device 30 shown in FIG. 1 performs service processing. The service server device 30 stores therein items of identification information for identifying registered users, and when a registered user logs in, the service server device 30 performs service processing.

The service server device 30 stores, in association with items of identification information, billing methods for charging a service fee to users identified by the items of identification information. Examples of the billing methods are: charging according to a volume, such as the amount of data or the number of pages (so-called measured-rate billing), charging at a flat rate up to the use of a service within a certain period (for example, one month) (so-called flat-rate billing), charging by measured-rate billing up to a certain price (also called a “cap”) and not charging for the use of a service in excess of this price within a certain period (called price-cap billing), and charging at a flat rate up to a certain volume and charging by measured-rate billing for the use of a service in excess of this volume within a certain period (called fixed-volume flat-rate billing). When the service server device 30 has performed service processing for providing a service to a user who has logged in by using an item of identification information stored in the service server device 30, it performs billing processing for billing the user for the provided service by using a billing method stored in association with this item of identification information. In this manner, concerning charged services provided in this exemplary embodiment, a billing method for a service fee is determined in association with each item of identification information.

Billing processing is processing for withdrawing a service fee from a bank account registered for a user or charging a service fee to a credit card or electronic money owned by a user. The service server device 30 also sends result data indicating results of performing service processing to, for example, an output device 20. The result data is data indicating an extracted difference if a difference extraction service is provided or a translated document if a translation service is provided.

The plural output devices 20 are each installed in a facility, such as a corner store, and outputs result data sent from the service server device 30. When using a charged service, a user operates an output device 20, and the output device 20 sends data necessary for the user to use a charged service (such data will be hereinafter referred to as “service usage data”) to the information processing apparatus 10. The service usage data includes parameters for performing service processing (for example, a format of data to be converted in data conversion services or a type of arrangement in music score arranging services) and original data if such data will be processed in service processing (for example, two items of data from which a difference will be extracted in difference extraction services or data representing a document to be translated in translation services).

Service usage data includes an access point of the service server device 30 which provides a charged service selected by a user and identification information of the user for logging in the service server device 30. Upon receiving plural items of identification information, the output device 20 sends service usage data including such plural items of identification information to the information processing apparatus 10. Such service usage data indicates that multiple users identified by the plural items of identification information will utilize the same charged service.

The output device 20 also has a function of forming an image on a medium, such as a sheet. With this function, the output device 20 forms an image indicating result data (for example, a translated text) sent from the service server device 30 on a medium. The output device 20 outputs result data in this manner.

The information processing apparatus 10 transfers service usage data sent from the output device 20 to the access point indicated by the service usage data, that is, the service server device 30 which provides a charged service selected by the user. In this case, the information processing apparatus 10 requests the service server device 30 to provide information concerning a billing method associated with identification information included in the service usage data. If plural items of identification information are included in the service usage data, plural billing methods are provided to the information processing apparatus 10. On the basis of the provided plural billing methods, the information processing apparatus 10 selects an item of identification information associated with the least expensive billing method, and calculates a price for each user to be charged when the service fee is distributed among the multiple users if the least expensive billing method is utilized (such a price will be hereinafter referred to as a “distributed price”).

In the information processing system 1, an item of identification information selected by the information processing apparatus 10 and a distributed price calculated by the information processing apparatus 10 are provided to each user through the output device 20. If the user accepts the content of the provided information, information indicating the user has accepted the provided information is sent to the service server device 30 and the information processing apparatus 10. Then, the service server device 30 performs service processing. The information processing apparatus 10 charges the calculated distributed prices to individual users, and also performs processing for paying a service fee charged by using the billing method associated with the selected identification information. In this case, this service fee is paid by a provider which provides the above-described distributed billing services. However, this provider collects the service fee paid by the provider in the form of the distributed prices from the multiple users. In this manner, a service fee is distributed among multiple users who will utilize the same charged service, and the distributed prices are charged to the individual users, thereby providing distributed billing services.

### [1-2] Hardware Configuration

FIG. 2 illustrates an example of the hardware configuration of the information processing apparatus 10. The information processing apparatus 10 is a computer including a controller 11, a storage device 12, and a communication device 13. The controller 11 includes a central processing unit (CPU), a read only memory (ROM), a random access memory (RAM), and a real time clock. The CPU executes a program stored in the ROM or the storage device 12 by using the RAM as a work area so as to control the individual elements. The real time clock calculates a current date and time and informs the CPU of the calculated date and time. The storage device 12 includes, for example, a hard disk, in which data, programs, and image data used for performing control by the controller 11 are stored. In the storage device 12, a processing program for performing processing for providing distributed billing services to users (hereinafter referred to as “distributed billing processing”) is stored. The communication device 13 includes a communication circuit for performing communication, which sends and receives data to and from the output devices 20 and the service server device 30 via the network 2.

### [1-3] Functional Configuration

With this hardware configuration, the information processing apparatus 10 performs distributed billing processing. The controller 11 controls the individual elements by executing the processing program stored in the storage device 12, thereby implementing the following functions.

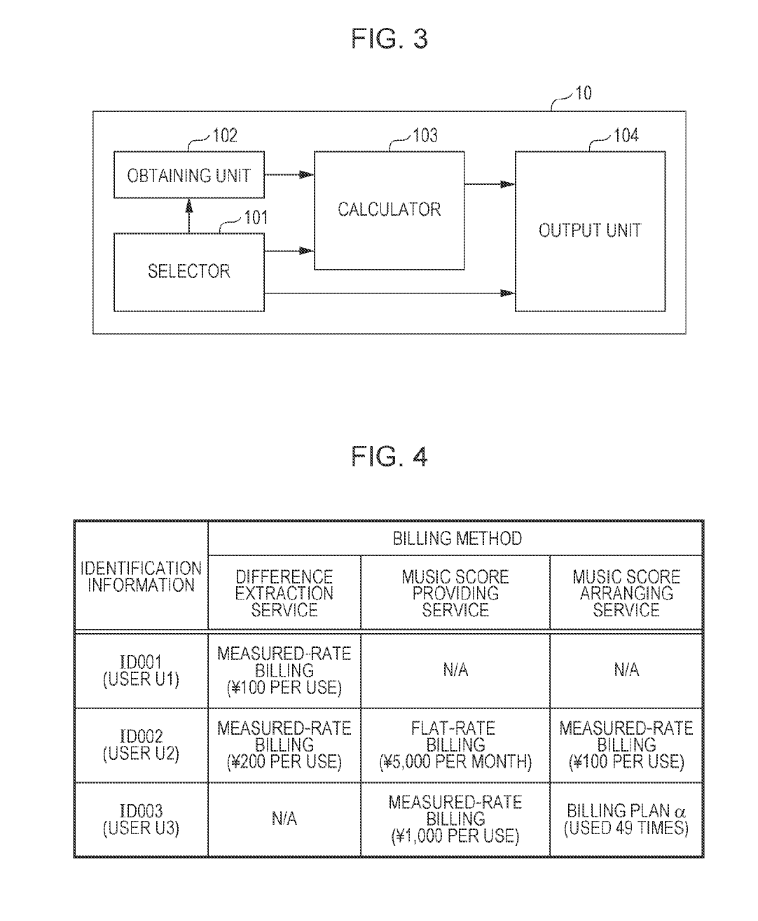

FIG. 3 illustrates an example of the functional configuration of the information processing apparatus 10. The information processing apparatus 10 includes functions, such as a selector 101, an obtaining unit 102, a calculator 103, and an output unit 104. These functions are operated when a charged service is utilized by multiple users. More specifically, these functions are operated when plural items of identification information are included in service usage data sent from the output device 20.

### [1-3-1] Selector 101

If billing methods for a service fee are determined and associated with plural items of identification information for identifying multiple users utilizing a charged service, the selector 101 serves as a unit for selecting one of the plural items of identification information. More specifically, the selector 101 selects one of the plural items of identification information on the basis of information indicating whether each user will benefit (hereinafter referred to as “benefit information”). The benefit information indicates service fees calculated by using individual billing methods (hereinafter referred to as “provisional fees”). The selector 101 is a function implemented by the controller 11, the storage device 12, and the communication device 13.

### [1-3-1-1] When Provisional Fees are Used as Benefit Information

If service usage data sent from the output device 20 includes plural items of identification information, the controller 11 sends request data for requesting the service server device 30 of the access point indicated by the service usage data to inform the information processing apparatus 10 of billing methods associated with these plural items of identification information and billing statuses of such billing methods. The billing status is, for example, a fee which has already been charged during a certain period if the above-described price-cap billing is utilized. Upon receiving such request data, the service server device 30 informs the information processing apparatus 10 of the billing methods stored in association with the plural items of identification information included in the request data and the billing statuses. The controller 11 then selects one of the plural items of identification information on the basis of the plural billing methods and the billing statuses. A specific method for selecting an item of identification information will be discussed below with reference to FIG. 4.

FIG. 4 is a table for explaining a method for selecting identification information. FIG. 4 shows that, concerning users U1, U2, and U3 identified by items of identification information “ID001”, “ID002”, and “ID003”, respectively, if a difference extraction service is provided, “measured-rate billing (¥100 per use)” (¥ is the unit of Japanese yen) is set for the user U11, “measured-rate billing (¥200 per use)” is set for the user U12, and “N/A” is set for the user U13 as the billing methods. N/A means that a billing method is undetermined for a corresponding user since such a user has not registered identification information and a corresponding charged service is not provided to such a user. FIG. 4 also shows that if a music score providing service is provided, “N/A” is set for the user U11, “flat-rate billing (¥5,000 per month)” is set for the user U12, and “measured-rate billing (¥1,000 per use)” is set for the user U13 as the billing methods. If a music score arranging service is provided, “N/A” is set for the user U11, “measured-rate billing (¥100 per use)” is set for the user U12, and “billing plan α” is set for the user U13 as the billing methods. Concerning the billing plan α, the billing status in which “used 49 times” is also indicated.

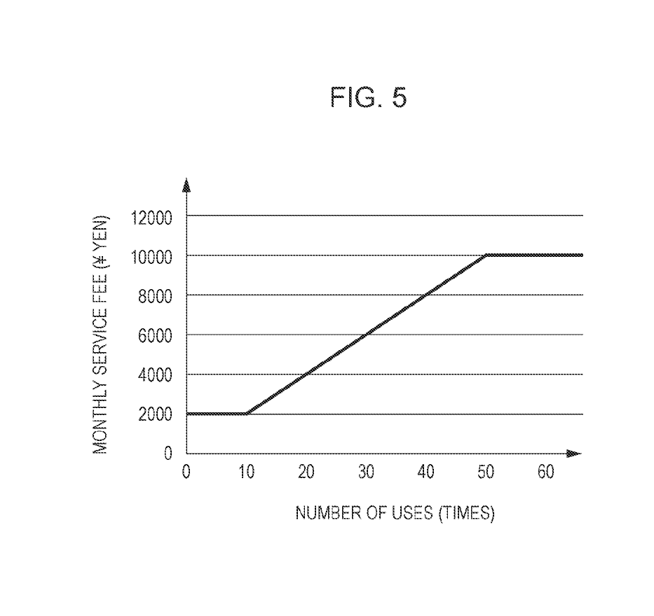

FIG. 5 is a graph for explaining the billing plan α. In FIG. 5, the horizontal axis indicates the number of uses (the number of times a charged service is utilized, in this example, the number of times a music score arranging service is utilized), and the vertical axis indicates a monthly service fee in terms of yen. The billing plan α is a plan as a combination of the above-described price-cap billing and fixed-volume flat-rate billing. More specifically, flat-rate billing at a rate of ¥2,000 is utilized until the number of uses is ten, and after that, measured-rate billing at a rate of ¥200 per use is utilized, and then, no charge is incurred when the service fee reaches ¥10,000. For example, if the service has been used 49 times, as indicated in the billing status shown in FIG. 4, the service fee has reached ¥9,800. Accordingly, if the service is used one more time and ¥200 is charged, the service fee reaches ¥10,000, and after that, no charge will be incurred.

In the example shown in FIG. 4, a music score provided by a music score providing service is arranged by utilizing a music score arranging service, and then, a difference between a music score before and after the arrangement is extracted. Then, data indicating the music scores before and after the arrangement and a difference between two scores is provided as result data. In this exemplary embodiment, in addition to service usage data, the number of times users will utilize a charged service (number of uses) is also input into the output device 20. The number of uses is also the number of times service processing will be performed and the number of times result data will be provided. The output device 20 informs the information processing apparatus 10 of the number of uses. The controller 11 then selects an item of identification information for each service on the basis of the number of uses and the billing method and the billing status, such as those shown in FIGS. 4 and 5, respectively.

Concerning the difference extraction service, the controller 11 compares a provisional fee for the user U1 with that for the user U2, excluding the user U3 for which the billing method is undetermined. If, for example, the number of uses is seven, the provisional fee for the user U1 is ¥700, while that for the user U2 is ¥1,400. Accordingly, the controller 11 selects an item of identification information associated with a less expensive fee, that is, the identification information of the user U1. Concerning the music score providing service, the provisional fee for the user U2 is ¥0 since the user U2 has already paid ¥5,000 by utilizing the flat-rate billing method, while the provisional fee for the user U3 is ¥7,000. Accordingly, the controller 11 selects identification information of the user U2 associated with a less expensive fee. Concerning the music score arranging service, the provisional fee for the user U2 is ¥700, while that for the user U3 is ¥200 (¥200 is charged for one more use and no charge is incurred after that since the total fee will reach ¥10,000). Accordingly, the controller 11 selects identification information of the user U3 associated with a less expensive fee.

As the provisional fee becomes less expensive, an actual service fee also becomes less expensive. Thus, each user will benefit from a less expensive fee. In this manner, a provisional fee serves as information indicating whether each user utilizing a charged service can benefit (that is, benefit information). The selector 101 selects items of identification information by using provisional fees as benefit information in this manner, and then, it outputs the selected items of identification information to the obtaining unit 102 and the output unit 104. The selector 101 also outputs the selected items of identification information (ID001, ID002, and ID003 in the example shown in FIG. 4) to the calculator 103 together with all of the plural items of identification information (ID001, ID002, and ID003 in the example shown in FIG. 4) included in the service usage data.

### [1-3-1-2] When Another Type of Benefit Information is Used

There may be a case in which points are provided by paying for a service fee. In this case, the selector 101 selects identification information by utilizing, as benefit information, points which will be expected to be obtained (hereinafter called “expected points”), a period in which a charged service will be utilized (hereinafter called a “period of use”), a location in which a charged service will be utilized (hereinafter called a “location of use”), or the content of a charged service (hereinafter called a “service content”).

In this case, “points” are points to be provided in accordance with the amount of money paid by using a credit card or electronic money. For example, it is assumed that the users U1 and U2 utilize the same measured-rate billing method (¥100 per use). However, for electronic money used by the user U1, one point is provided for each purchase of ¥100, while, for electronic money used by the user U2, three points are provided for each purchase of ¥100. In this case, regardless of the number of uses, more points are provided by logging in the service server device 30 by utilizing identification information of the user U2. Accordingly, the selector 101 selects the identification information of the user U2.

There may be another case in which a campaign is carried out (for example, a free gift is given or a cashback is offered) during a limited period of time if payment is settled by using a credit card or electronic money. In this case, the selector 101 selects identification information of a user who settles payment by utilizing a payment method in which a period of use is included in a campaign period. A campaign may be carried out by restricting a location of use. For example, it is assumed that, when obtaining result data by using the output device 20 installed in a certain corner store, if a user settles payment for such result data by using electronic money having a business tie-up with this corner store, a cashback is offered. In this case, the selector 101 selects identification information of a user who settles payment by utilizing a payment method in which a location of use is a target of this campaign.

There may be another case in which a provider providing charged services may offer a special incentive for a specific charged service with a discount if payment is settled by using electronic money having a business tie-up with this provider. In this case, if a used charged service is a specific charged service, the selector 101 selects identification information of a user who settles payment by using a payment method which allows a user to have a discount.

As discussed above, expected points, the period of use, the location of use, and the service content all serve as information indicating whether a payment price this time or a next time will be reduced by a cashback, a discount, or points (that is, benefit information). The selector 101 selects identification information on the basis of such benefit information.

### [1-3-2] Obtaining Unit 102

The obtaining unit 102 is an example of a unit which obtains fee information indicating a fee of a charged service (service fee) used by multiple users. In this exemplary embodiment, the obtaining unit 102 obtains, as fee information, information indicating a service fee charged by using a billing method which is determined in association with identification information selected by the selector 101. In the example shown in FIG. 4, the obtaining unit 102 obtains, as fee information, a total of ¥900 including ¥700, which is a provisional fee of the user U1 in the case of a difference extraction service, ¥0, which is a provisional fee of the user U2 in the case of a music score providing service, and ¥200, which is a provisional fee of the user U3 in the case of a music score arranging service. The obtaining unit 102 supplies the obtained fee information to the calculator 103.

### [1-3-3] Calculator 103

The calculator 103 is an example of a unit which calculates distributed prices to be charged when a service fee indicated by fee information obtained by the obtaining unit 102 is distributed among multiple users. For example, the calculator 103 calculates distributed prices, on the basis of whether or not a user to pay for a service fee is a user identified by an item of identification information selected by the selector 101. The calculator 103 determines a service fee indicated by the fee information supplied from the obtaining unit 102 by utilizing this fee information. In the example shown in FIG. 4, all of the users U1, U2, and U3 are users identified by the items of identification information selected by the selector 101. Accordingly, the calculator 103 calculates a distributed price for each user so that the determined service fee will be equally distributed among the users, that is, ¥900÷3=¥300.

On the other hand, if the users U1 and U2 are users identified by the items of identification information selected by the selector 101 and if the user U3 is not a user identified by the items of identification information selected by the selector 101, the calculator 103 calculates a distributed price for each user so that, for example, the distributed price for the user U3 will be twice as much as that of the users U1 and U2 (that is, if the service fee is ¥900, the distributed price for the users U1 and U2 is ¥225, while the distributed price for the user U3 is ¥450).

The calculator 103 also calculates distributed prices, on the basis of how much a service fee has become less expensive by selecting a certain item of identification information than a service fee if another identification information were selected, that is, on the basis of a degree of contribution to reducing a service fee (hereinafter such a degree will be referred to as a “contribution degree”). In the example shown in FIG. 4, in the case of the user U1, the service fee for a difference extraction service has been reduced by ¥700 by selecting the identification information of the user U1 than by selecting that of the user U2 (¥1,400-¥700=¥700). In this case, the contribution degree of the user U1 is ¥700.

In the case of the user U2, the service fee for a music score providing service has been reduced by ¥7,000 by selecting the identification information of the user U2 than by selecting that of the user U3 (¥7,000-¥0=¥7,000), and thus, the contribution degree of the user U2 is ¥7,000. In the case of the user U3, the service fee for a music score arranging service has been reduced by ¥500 by selecting the identification information of the user U3 than by selecting that of the user U2 (¥700-¥200=¥500), and thus, the contribution degree of the user U3 is ¥500. The calculator 103 calculates a distributed price for each user by using a ratio of the reciprocals of the contribution degrees of the individual users as a ratio of the distributed prices for the users. In the example shown in FIG. 4, the ratio of the distributed prices for the users U1, U2, and U3 is 1/700:1/7000:1/500. Thus, the calculator 103 calculates the distributed prices for the users U1, U2, and U3 as ¥360, ¥36, and ¥504, respectively, from the service fee ¥900.

The calculator 103 informs the output unit 104 of the distributed prices calculated in this manner, together with the items of identification information of the users who will pay these distributed prices.

### [1-3-4] Output Unit 104

The output unit 104 is an example of a unit which outputs data indicating distributed prices calculated by the calculator 103 and items of identification information for identifying users billed for these distributed prices (hereinafter such data will be referred to as “distributed price data”). The output unit 104 outputs the distributed price data to a destination of an entity for billing the users (hereinafter referred to as a “billing destination”). In this exemplary embodiment, the output unit 104 utilizes, as a billing destination, the destination of a system managed by a transfer service provider which provides transfer services. In the transfer services, a distributed price is withdrawn from an account of a user identified by an item of identification information, and a withdrawn price is transferred to an account of a provider providing distributed billing services. Such a system will be referred to as a “transfer system”. The output unit 104 outputs data indicating the distributed prices and the items of identification information supplied from the calculator 103 to the billing destination as the distributed price data. The transfer system withdraws the distributed prices indicated by the distributed price data from the accounts of the users identified by the items of identification information and transfers the withdrawn distributed prices to the account of the provider providing distributed billing services. In this manner, billing to users and payment for distributed prices is performed.

The output unit 104 also outputs fee information indicating a service fee charged by using billing methods which are determined in association with items of identification information selected by the selector 101 to a destination for paying for the service fee (hereinafter referred to as a “payment destination”). In this exemplary embodiment, the output unit 104 outputs fee information by using the destination of the transfer system, which is the above-described billing destination, as the payment destination. The transfer system transfers the service fee indicated by the output fee information from the account of the provider providing distributed billing services to the account of a provider providing a charged service. In this manner, payment for a service fee is settled.

As discussed above, through the output operation performed by the output unit 104, the transfer system performs processing for billing a user for a service fee on behalf of a provider providing a charged service. Hereinafter, this processing will be referred to as “billing and collecting processing”.

### [1-4] Operation

With the above-described configuration, the information processing system 1 performs the above-described distributed billing processing (processing for providing distributed billing services to users).

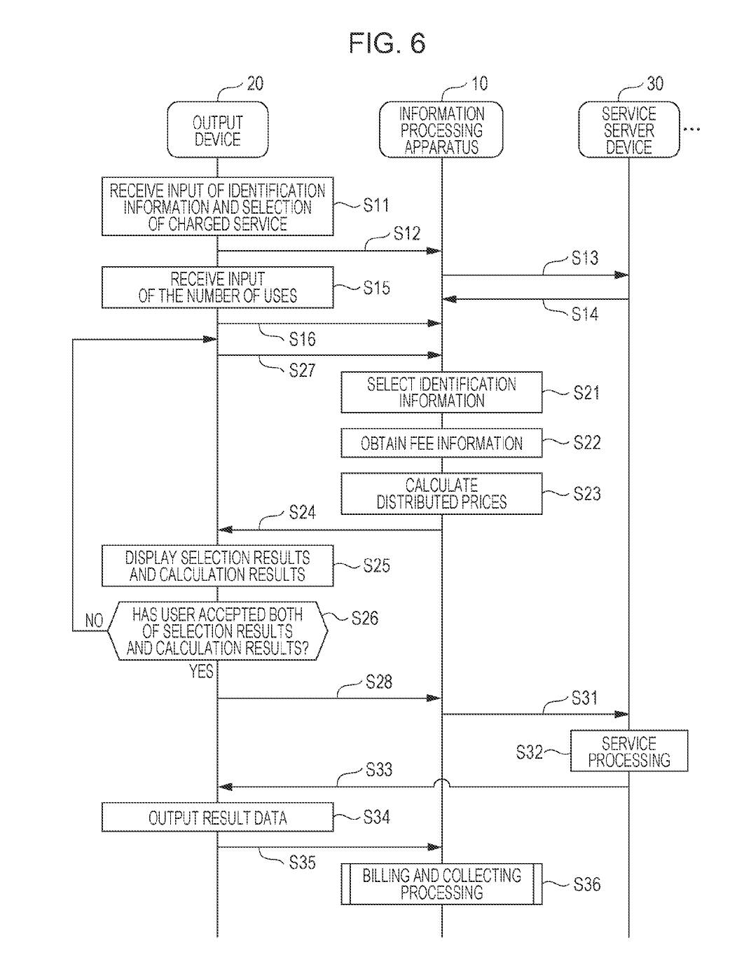

FIG. 6 is a sequence diagram illustrating examples of operations performed by the output unit 20, the information processing apparatus 10, and the service server device 30 when performing distributed billing processing. In the example shown in FIG. 6, only one service server device 30 is shown; however, in practice, plural service server devices 30 are operated, and operations performed by all the service server devices 30 are assumed to be the same, unless otherwise specified. Distributed billing processing is started by a user operating the output device 20 to use a charged service and inputting plural items of identification information.

In step S11, the output device 20 receives an operation for inputting plural items of identification information and selecting a charged service from a user. In this case, one charged service may be selected, or plural charged services may be selected. Then, in step S12, on the basis of the content of the received operation, the output device 20 sends service usage data indicating the input plural items of identification information and an access point of a service server device 30 which provides the selected charged service to the information processing apparatus 10, and the information processing apparatus 10 receives the service usage data. Then, in step S13, the information processing apparatus 10 sends the service usage data and the above-described request data (which includes a request to supply information concerning billing methods and billing statuses thereof) to the service server device 30 of the access point included in the service usage data received in step S12.

In step S14, the service server device 30 informs the information processing apparatus 10 of billing methods and billing statuses thereof stored in association with the items of identification information indicated by the request data received in step S13. Steps S13 and S14 are executed by all service server devices 30 associated with access points included in the service usage data if plural access points are included. After step S11, in step S15, the output device 20 receives an operation for inputting the number of uses for a charged service (the number of times the charged service will be utilized). Then, in step S16, the output device 20 informs the information processing apparatus 10 of the number of uses for the charged service.

In step S21, the information processing apparatus 10 selects one of the plural items of identification information included in the service usage data for each service, on the basis of the information received in step S14 and the information received in step S16. Steps S12 through S14, step S16 and step S21 are executed by the selector 101. Then, in step S22, the information processing apparatus 10 obtains fee information indicating a service fee on the basis of the selected item of identification information. Step S22 is executed by the obtaining unit 102. Then, in step S23, the information processing apparatus 10 calculates distributed prices for the service fee indicated by the obtained fee information. Step S23 is executed by the calculator 103.

In step S24, the information processing apparatus 10 outputs the items of identification information, which are selection results of step S21, and the distributed prices, which are calculation results of step S23, to the output device 20. In step S25, the output device 20 displays the received selection result and calculation results.

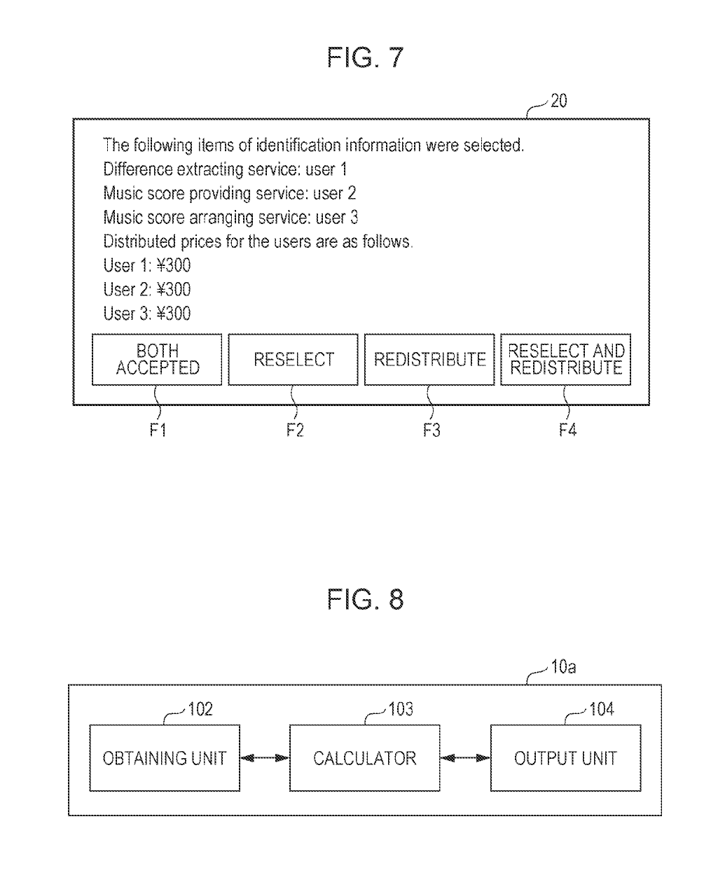

FIG. 7 illustrates an example of the displayed selection results and calculation results. In this example, on an operation panel of the output device 20, users identified by the selected items of identification information and distributed prices obtained by equally distributing the service fee among the users, as discussed in the example shown in FIG. 4, are displayed. On this operation panel, operator images F1, F2, F3, and F4 indicating operators including character strings “BOTH ACCEPTED”, “RESELECT”, “REDISTRIBUTE”, and “RESELECT AND REDISTRIBUTE”, respectively, are also displayed.

In step S26, the output device 20 determines whether the user has accepted both of the selection results and the calculation results. If the user has selected one of the operator images F2, F3, and F4, the output device 20 determines that the result of step S26 is NO. Then, in step S27, the output device 20 informs the information processing apparatus 10 that the user has not accepted at least one of the results. Then, the information processing apparatus 10 reselects an item of identification information for each service in step S21 or recalculates distributed prices in step S23, depending on the result rejected by the user. The information processing apparatus 10 reselects an item of identification information and recalculates distributed prices if the user has accepted neither of the results. For example, the information processing apparatus 10 performs selection processing so that selection results will be different every time step S21 is executed, such as selection processing is performed by using provisional fees for the first time, by using expected points for the second time, and by using the period of use for the third time.

As in step S21, in step S23, the information processing apparatus 10 performs calculation processing, for the first time, based on whether or not a user to pay for a service fee is a user identified by a selected item of identification information, and for the second time, on the basis of the contribution degrees. For the third time and thereafter, the information processing apparatus 10 may change how to use the contribution degrees. For example, the information processing apparatus 10 performs calculation processing by utilizing the reciprocals of the contribution degrees for the second time. Then, for the third time, the information processing apparatus 10 may calculate the distributed prices at a ratio of 1:2:3 in descending order of contribution degree, and for the fourth time, the information processing apparatus 10 may change the ratio to 1:3:5. In short, the information processing apparatus 10 executes step S23 so that the distributed prices will be different every time step S23 is executed. In this manner, by repeating steps S21 through S27, if the output device 20 determines in step S26 that the user has accepted both of the selection results and the calculation results, the process proceeds to step S28. In step S28, the output device 20 informs the information processing apparatus 10 that the user has accepted both of the selection results and the calculation results.

Then, in step S31, the information processing apparatus 10 informs the service server device 30 to which the information processing apparatus 10 has sent the service usage data and the request data in step 13 that the user has accepted both of the selection results and the calculation results. The service server device 30 which receives this information is the service server device 30 which provides the charged service selected as a result of the user performing the operation in step S11. Then, in step S32, the service server device 30 performs service processing on the basis of the service usage data received in step S13. Then, in step S33, the service server device 30 sends result data obtained by performing service processing to the output device 20. In step S34, the output device 20 outputs the received result data. As a result, the charged service selected by the user is provided.

After outputting the result data, in step S35, the output device 20 informs the information processing apparatus 10 that the result data has been output. Then, in step S36, upon receiving information that the result data has been output, that is, the charged service has been provided to the user, the information processing apparatus 10 performs billing and collecting processing. More specifically, the information processing apparatus 10 outputs distributed price data to the above-described billing destination and outputs fee information to a payment destination. Step S36 is executed by the output unit 104.

### [1-5] Summary of First Exemplary Embodiment

In an information processing system, charged services may be provided in the form of, for example, cloud services. In such cloud services, for enabling any device connected to a network to use services, users are usually requested to register identification information, such as user IDs, and when a user logs in by using registered identification information, a charged service is provided to the user. Billing for a service fee is also performed by using a billing method (flat-rate billing or measured-rate billing) determined in association with identification information used by a user to log in to the system. Accordingly, even if multiple users have used a certain charged service, the total service fee is charged to a user who has registered its identification information used for logging in to the system. Then, this user has to settle the payment with the other users later in order to distribute the service fee among all the users.

According to the first exemplary embodiment, when service usage data including plural items of identification information is sent to the information processing apparatus 10, a charged service based on this service usage data is provided to multiple users identified by the plural items of identification information, and also, data (the above-described distributed price data) indicating distributed prices obtained by distributing a service fee among the users and the items of identification information of the users to pay for the distributed prices is sent to a billing destination. With this arrangement, the distributed prices are charged to the users identified by the items of identification information, and the fee of the service used by the multiple users is shared among the users.

In the first exemplary embodiment, by the use of benefit information, identification information is selected on the basis of whether or not each of multiple users will benefit. For example, in the example shown in FIG. 4, identification information associated with a less expensive provisional fee is selected for each service, and as a result, a service fee, that is, a total amount of distributed prices paid by multiple users, becomes less expensive than that if a different item of identification information were selected.

In the first exemplary embodiment, in addition to provisional fees, expected points are used as benefit information. Accordingly, assuming that there is a user to which many points will be provided if payment is settled by utilizing a billing method associated with this user, many points may be obtained by utilizing the identification information of this user. Additionally, if an incentive offer, such as a cashback, a discount, or points, is provided depending on the period of use, location of use, the content of a charged service, identification information which is likely to receive greater benefits may be selected.

### [2] Second Exemplary Embodiment

A description will now be given of a second exemplary embodiment of the present invention, and, in particular, points different from those of the first exemplary embodiment will be discussed. In the first exemplary embodiment, identification information is selected, and distributed prices are calculated on the basis of the selected identification information. In the second exemplary embodiment, identification information is not selected, and instead, distributed prices are calculated on the basis of another type of information. This information concerns factors that may vary a fee of a charged service (hereinafter such information will be referred to as “variable information”).

As stated above, charged services are provided in the form of cloud services. In the second exemplary embodiment, a service fee varies depending on the number of times a charged service is used (the number of uses), a period for which result data is stored (hereinafter referred to as a “storage period”), a CPU load imposed by service processing (for example, the maximum CPU utilization ratio while performing service processing), and a storage space secured for performing service processing (which is not a capacity of a storage device, but a space of an area of a storage device secured for service processing). In the second exemplary embodiment, these items of information (the number of uses, the storage period, the CPU load, and the storage space) are used as variable information.

In the second exemplary embodiment, a provider a which provides distributed billing services integrates a charged service provided by the provider a (in-house service A) and charged services provided by other providers b, c, and d (other companies' services B, C, and D), thereby providing integrated services. Such services will be hereinafter referred to as “integrated function services”. It is assumed that the in-house service A is a difference extraction service and is provided by the information processing apparatus 10 and that the other companies' services B, C, and D are a data conversion service, an OCR service, and a translation service, respectively, and are provided by the service server devices 30.

By using the integrated function services, the following integrated services, for example, are provided. The format of document data of a user is converted by a data conversion service, characters are extracted from the converted document data by an OCR service, and then, the extracted characters are translated into Japanese by a translation service. Another charged service may also be integrated in the integrated function services.

In the second exemplary embodiment, a user U1 requests integrated function services by operating a certain output device 20. Then, in response to this request, service processing for charged services included in the requested integrated function services is performed, and result data indicating processing results is output onto a sheet from another output device 20, thereby allowing a user U2 to receive the result data indicating the results provided by the integrated function services. A description will be given below of a case in which a requester (user U1 in the second exemplary embodiment) requesting the integrated function services and a receiver (user U2 in the second exemplary embodiment) receiving the services are different.

### [2-1] Functional Configuration

FIG. 8 illustrates an example of the functional configuration of an information processing apparatus 10a of the second exemplary embodiment. The information processing apparatus 10a includes, as shown in FIG. 8, the obtaining unit 102, the calculator 103, and the output unit 104 shown in FIG. 3. In the second exemplary embodiment, since the selector 101 is not provided, the obtaining unit 102 obtains fee information in a manner different from that of the first exemplary embodiment.

### [2-1-1] Obtaining Unit 102

As in the selector 101, the obtaining unit 102 sends request data to a service server device 30 by utilizing user identification information included in service usage data sent from the output device 20, and obtains information concerning billing methods and billing statuses thereof as fee information. The obtaining unit 102 may also obtain parameters included in the service usage data or user providing data provided by a user as fee information, provided that billing methods are measured-rate billing and the amount that varies a service fee may be determined from the parameters or user providing data.

For example, if a service fee varies depending on the number of characters of a document to be translated in a translation service, user providing data which indicates text to be translated serves as fee information. If there are different levels of definition for image recognition processing in an OCR service and if the measured-rate billing method varies depending on the level of definition (for example, in the case of level 1, ¥10 per page, in the case of level 2, ¥20 per page, and so on), a parameter indicating the level of definition serves as fee information. In this manner, the obtaining unit 102 obtains information necessary for determining a service fee as fee information.

The above-described items of fee information all indicate a service fee in an indirect manner. However, the obtaining unit 102 may send query data for querying the service server device 30 to which the service usage data has been transferred about a service fee, and may obtain information concerning a service fee responded from the service server device 30 as fee information. In short, the obtaining unit 102 may obtain fee information in any manner as long as it can obtain information indicating fees of charged services to be used by multiple users (that is, fee information).

### [2-1-2] Calculator 103

The calculator 103 calculates distributed prices on the basis of the above-described variable information. More specifically, the calculator 103 calculates distributed prices by using, as variable information, the number of uses, the storage period, the CPU load imposed by service processing, and the storage space secured for performing service processing. The calculator 103 stores data representing correlations between these items of variable information and distribution ratios (hereinafter referred to as “correlation data”). The distribution ratio is a ratio of a distributed price for each of a requester and a receiver for a charged service to a service fee if the service fee is distributed between the requester and the receiver.

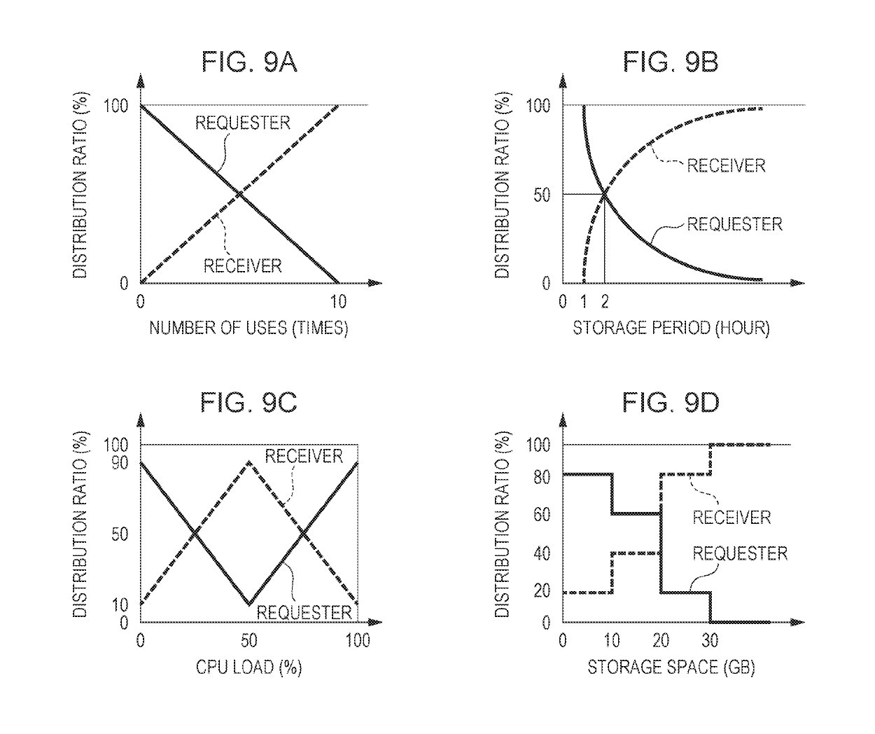

FIGS. 9A through 9D are diagrams illustrating examples of correlation data. FIGS. 9A through 9D illustrate correlation data indicating correlations between the distribution ratios and items of variable information, such as the number of uses, the storage period (in hours), the CPU load (in percentages (%)), and the storage space (in gigabytes (GB)), respectively. In all the examples, the horizontal axis indicates variable information, while the vertical axis indicates the distribution ratio, and the distribution ratio of the requester is indicated by the solid line, while the distribution ratio of the receiver is indicated by the broken line. The total of the distribution ratio of the requester and that of the receiver is 100% regardless of the type of variable information.

In FIG. 9A, the distribution ratio of the requester is 100% when the number of uses is 0. As the number of uses increases, the distribution ratio of the requester decreases at a certain rate, and becomes 0% when the number of uses exceeds 10. The distribution ratio of the requester and that of the receiver are expressed by the following equations:

distribution ratio of requester=(100−k×the number of uses) % (k is 10 in this example); and

distribution ratio of receiver=(100−distribution ratio of requester) %.

Both of the distribution ratios are in a range of 0% to 100%.

In FIG. 9B, the distribution ratio of the receiver is 0% until the storage period is up to one hour. When the storage period exceeds one hour, the distribution ratio sharply increases, and then gently increases and approximates to 100%. The distribution ratio of the requester and that of the receiver are expressed by the following equations (the storage period is measured in hours):

distribution ratio of requester=(100−distribution ratio of requester) %; and

distribution ratio of receiver=((1−1÷storage period)×100) %.

In this example, if the storage period is two hours, both of the distribution ratios of the requester and the receiver are 50%.

In FIG. 9C, the distribution ratio of the requester is 90% when the CPU load is 0%. As the load increases, the distribution ratio of the requester decreases at a certain rate and becomes 10% when the load is 50%. Then, as the load further increases, the distribution ratio of the requester increases at a certain rate and becomes 90% again when the load is 100%. In FIG. 9D, the distribution ratio of the requester is 80%, 60%, and 20% until the storage space is 10 GB, 20 GB, and 30 GB, respectively, and then becomes 0% when the storage space exceeds 30 GB.

As shown in FIGS. 9A through 9D, the correlation indicated by the correlation data may be linear, as shown in FIG. 9A, or nonlinear, as shown in FIG. 9B. Additionally, the sign of a gradient of the correlation may be changed from the positive side to the negative side, and vice versa, as shown in FIG. 9C, or the distribution ratios may be changed in a stepwise manner in accordance with the range of values of variable information, as shown in FIG. 9D.

In the second exemplary embodiment, for each combination of a user and a charged service, a billing method and a distribution ratio are determined. The calculator 103 stores therein a distribution ratio table in which charged services, billing methods, and distribution ratios are associated with identification information of a user.

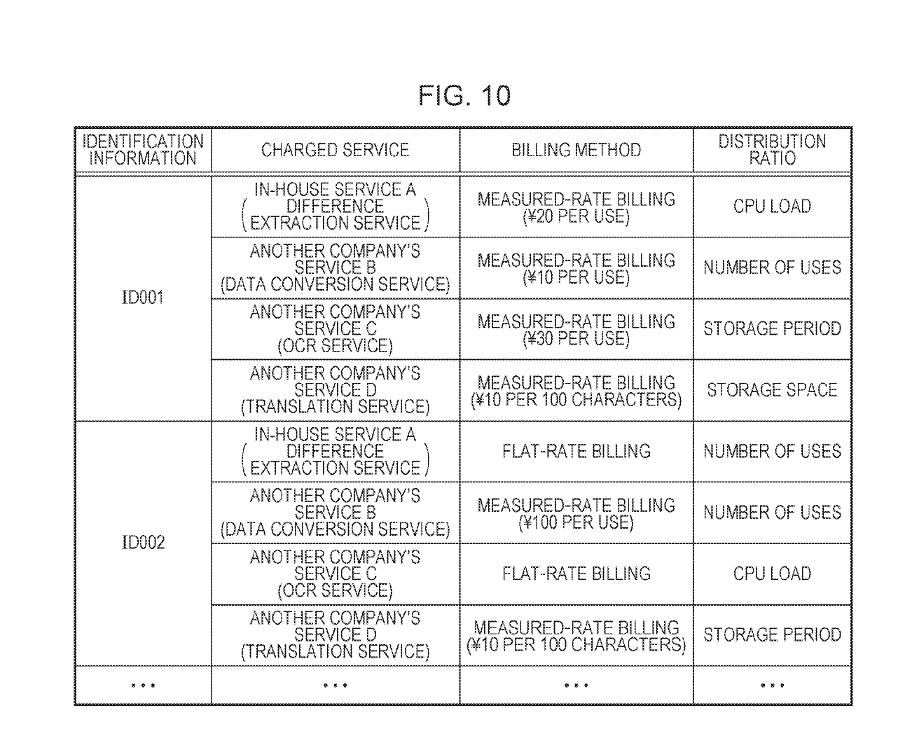

FIG. 10 illustrates an example of the distribution ratio table. In this example, charged services, such as “in-house service A (difference extraction service)”, “another company's service B (data conversion service)”, “another company's service C (OCR service)”, and “another company's service D (translation service)”, billing methods, such as “measured-rate billing (¥20 per use)”, “measured-rate billing (¥10 per use)”, “measured-rate billing (¥30 per use)”, and “measured-rate billing (¥10 per 100 characters)”, and distribution ratios, such as “CPU load”, “the number of uses”, “storage period”, and “storage space”, respectively, are associated with ID001, which is the identification information of the user U1. Additionally, the same charged services as those for the user U1, billing methods, such as “flat-rate billing”, “measured-rate billing (¥100 per use)”, “flat-rate billing”, and “measured-rate billing (¥10 per 100 characters)”, and distribution ratios, such as “the number of uses”, “the number of uses”, “CPU load”, and “storage period”, respectively, are associated with ID002, which is the identification information of the user U2.

When utilizing the above-described integrated function services, the requester selects charged services to be used by operating the output device 20. The output device 20 displays a selection image for instructing the requester to select charged services.

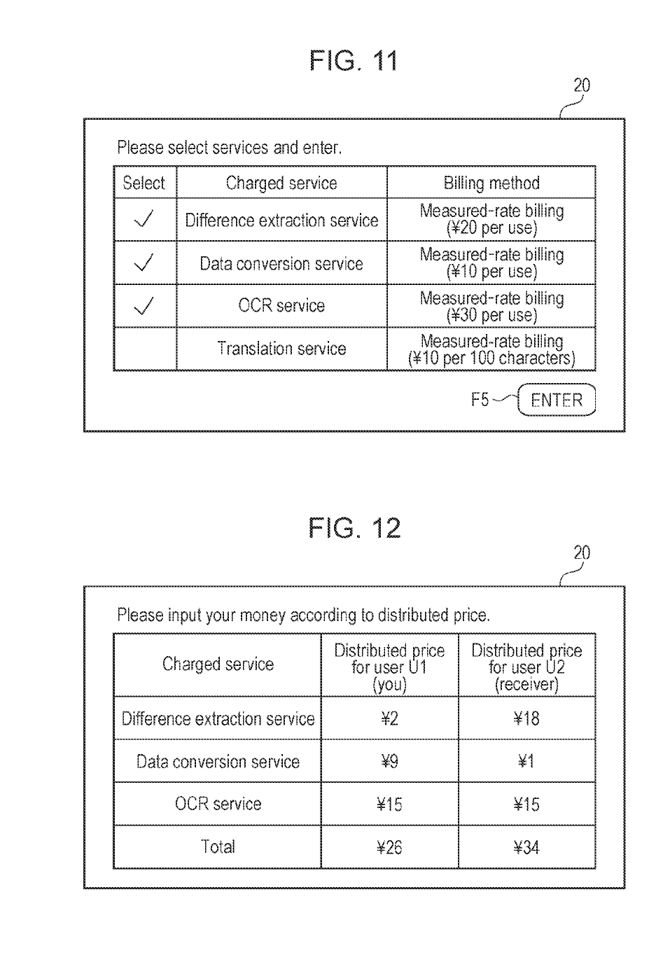

FIG. 11 illustrates an example of the selection image. In this example, the output device 20 displays a character string “Please select services and enter.”, the charged services and billing methods associated with the identification information ID001 shown in FIG. 10, columns for checking services selected from the charged services, and an operator image F5 including a character string “ENTER”. These charged services and billing methods are displayed as a result of the information processing apparatus 10 supplying information concerning the charged services and billing methods in the distribution ratio table associated with the requester's identification information included in the service usage data to the output device 20.

When the requester has selected charged services and entered the operator image F5, service usage data indicating the selected charged services is sent to the information processing apparatus 10. It is assumed that inputting of parameters and specifying or reading of user providing data for using each of the selected charged services has already been performed. It is also assumed that the output device 20 sends service usage data every time a requester uses integrated function services. When a requester uses integrated function services the second time or thereafter, service usage data indicates information to be added or changed to or from the previous usage data.

The calculator 103 determines fees of the charged services indicated by the received service usage data by utilizing fee information obtained by the obtaining unit 102. For example, in the example shown in FIG. 11, the calculator 103 determines the service fee of the in-house service A (difference extraction service) to be ¥20, the service fee of another company's service B (data conversion service) to be ¥10, and the service fee of another company's service C (OCR service) to be ¥30. The calculator 103 also obtains variable information necessary for determining the distribution ratios (in this example, the number of uses, the storage period, and the CPU load).

For example, the calculator 103 counts how many times service usage data including the items of identification information of the users U1 and U2 as the requester and the receiver, respectively, has been sent, and determines the counted number to be the number of uses. The CPU load and the storage period are not determined until services are actually provided. Accordingly, the calculator 103 obtains predetermined values (default values) of the CPU load and the storage period as variable information. Alternatively, if the integrated function services were used before, actual values of the CPU load and the storage period (average value if there are plural actual values for each of the CPU load and the storage period) are determined to be variable information.

The calculator 103 determines service fees indicated by fee information supplied from the obtaining unit 102, and calculates distributed ratios by using the determined service fees and the obtained variable information. For example, it is assumed that the calculator 103 has obtained a past actual value (50%) of the CPU load, the number of uses (one), and a default value (two hours) of the storage period. In this case, by using the fee of the in-house service A (¥20) and the distribution ratios (10% for the requester and 90% for the receiver) when the CPU load is 50%, as shown in FIG. 9C, the calculator 103 calculates the requester's distributed price as 20×0.1=¥2 and the receiver's distributed price as 20×0.9=¥18.

By using the fee of another company's service B (¥10) and the distribution ratios (90% for the requester and 10% for the receiver) when the number of uses is one, as shown in FIG. 9A, the calculator 103 calculates the requester's distributed price as 10×0.9=¥9 and the receiver's distributed price as 10×0.1=¥1. By using the fee of another company's service C (¥30) and the distribution ratios (50% for the requester and 50% for the receiver) when the storage period is two hours, as shown in FIG. 9B, the calculator 103 calculates the requester's distributed price as 30×0.5=¥15 and the receiver's distributed price as 30×0.5=¥15. The calculator 103 calculates a total of the calculated distributed prices for the requester, that is, 2+9+15=¥26, as the requester's distributed price, and a total of the calculated distributed prices for the receiver, that is, 18+1+15=¥34, as the receiver's distributed price.

The calculator 103 associates the calculated distributed prices with the items of identification information of users to pay for the distributed prices and the corresponding charged services, and supplies associated items of data to the output unit 104 as distributed price data.

### [2-1-3] Output Unit 104

The output unit 104 determines fees of the charged services by adding the distributed prices associated with the charged services by using the distributed price data, and outputs fee information indicating the determined fees to a payment destination. In the second exemplary embodiment, the destination of the above-described transfer system is used as the payment destination.

In the second exemplary embodiment, a money storage box (also called a coinkit) in which coins are stored and change is returned is connected to the output device 20, and billing and payment is performed by way of this money storage box. Accordingly, the output unit 104 outputs distributed price data to the output device 20 operated by a requester and a receiver as a billing destination. The output device 20 displays distributed prices indicated by the distributed price data received from the output unit 104.

FIG. 12 illustrates an example of the displayed distributed prices. The output device 20 displays that “distributed prices for the user U1 (you)” for the difference extraction service, the data conversion service, and the OCR service are ¥2, ¥9, and ¥15, respectively, and the total price is ¥26, and that “distributed prices for the user U2 (receiver)” for the difference extraction service, the data conversion service, and the OCR service are ¥18, ¥1, and ¥15, respectively, and the total price is ¥34. Then, the requester and the receiver each input the amount of money associated with the distributed prices into the money storage box. Then, the integrated function services are provided.

Instead of using a coinkit, the money storage box may be a reader/writer for electronic funds transfer or a reader for credit cards.

### [2-2] Operation

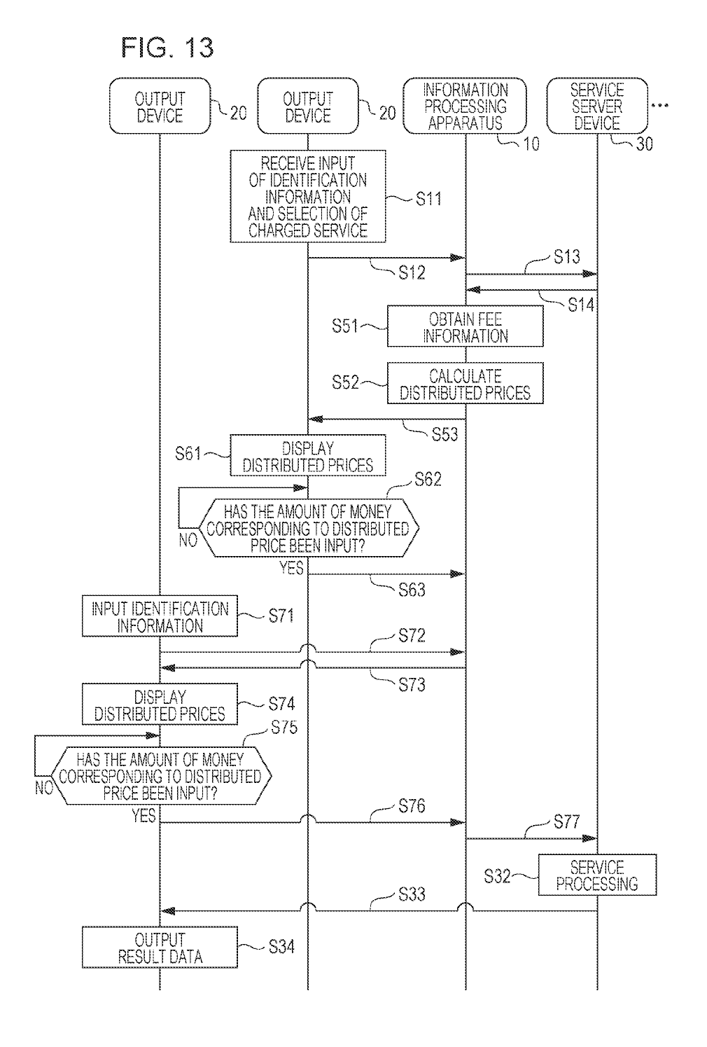

FIG. 13 is a sequence diagram illustrating examples of operations performed by the output units 20, the information processing apparatus 10, and the service server device 30 when performing distributed billing processing in the second exemplary embodiment. In this example, a requester (user U1 in this exemplary embodiment), inputs identification information of the user U1 and that of a receiver and selects charged services. In this manner, steps S11 through S14 shown in FIG. 6 are executed. Then, in step S51, the information processing apparatus 10 obtains information indicating billing methods and billing statuses thereof supplied in step S14 as fee information. In the first exemplary embodiment in FIG. 6, steps S12 through S14 are executed by the selector 101. In the second exemplary embodiment in FIG. 6, however, steps S12 through S14 and step S51 are executed by the obtaining unit 102.

Then, in step S52, the information processing apparatus 10 calculates distributed prices from service fees which are determined from the fee information. In step S53, distributed price data indicating the calculated distributed prices is output to the output device 20 which has sent the service usage data in step S12. Then, in step S61, the output device 20 displays the distributed prices indicated by the distributed price data received in step S53, for example, as in FIG. 12. In step S62, the output device 20 determines whether the amount of money corresponding to the distributed price for the requester has been input into a money storage box connected to the output device 20. If the result of step S62 is NO, step S62 is repeatedly executed. If the result of step S62 is YES, the process proceeds to step S63. In step S63, the output device 20 informs the information processing apparatus 10 that the amount of money corresponding to the distributed price for the requester has been input.

When a receiver (user U2 in this exemplary embodiment) has input identification information of the receiver to another output device 20, this output device 20 receives the identification information input in step S71. Then, in step S72, the output device 20 supplies the input identification information to the information processing apparatus 10. Since the identification information of the user U2 is the same as that of the receiver, in step S73, the information processing apparatus 10 sends the distributed price data to the output device 20 that has supplied the identification information. There may be a case in which step S72 has been executed prior to step S53 (sending of the distributed price data to the output device 20 of the requester), that is, a case in which the receiver, as well as the requester, has logged in). In this case, the information processing apparatus 10 executes step S73 and step S53 at the same time.

In step S74, the output device 20 displays the distributed prices included in the distributed price data supplied in step S73. The output device 20 then determines in step S75 whether the amount of money corresponding to the distributed price for the receiver has been input. If the result of step S75 is NO, step S75 is repeatedly executed. If the result of step S75 is YES, the process proceeds to step S76. In step S76, the output device 20 informs the information processing apparatus 10 that the amount of money corresponding to the distributed price for the receiver has been input. If, in step S63 and S76, the information processing apparatus 10 has received information that the amounts of money corresponding to the distributed prices have been input by the requester and the receiver, in step S77, the information processing apparatus 10 supplies this information to the service server device 30 that has received the service usage data in step S13. Thereafter, step S32 (service processing) through step S34 (output of result data) shown in FIG. 6 are executed. In this manner, integrated function services are provided.

### [2-3] Summary of Second Exemplary Embodiment

In the second exemplary embodiment, as well as in the first exemplary embodiment, distributed prices are calculated, and distributed price data is output. Then, a fee of services used by multiple users is shared among the users.

In the second exemplary embodiment, the distribution ratios of a requester and a receiver vary depending on variable information. For example, if the storage period shown in FIG. 9B is used as the variable information, the distributed price for the receiver increases as the storage period becomes longer. Accordingly, the receiver tries to reduce the storage period as short as possible. In cloud services, a service may be charged according to how long it is used. Thus, for a provider a which provides integrated function services, service fees to be paid to other providers which provide other services are likely to be less expensive as the storage period becomes shorter.

It is now assumed that the CPU load is used as variable information, and the CPU load is reduced if user providing data is preprocessed (for example, deleting portions other than text portions to be translated in advance). In this case, the distribution ratio of a requester who preprocesses user providing data is determined so that it will be decreased as the CPU load becomes smaller. Similarly, concerning the number of uses or the storage space, it is assumed that, if a requester or a receiver performs a certain operation, the number of uses or the storage space is reduced. In this case, the distribution ratio is determined so that it will be decreased if the requester or the receiver performs such an operation.

### [2-4] Other Types of Variable Information

The calculator 103 may use another type of variable information other than the above-described types, for example, the frequency with which a charged service is used (called a “frequency of use”), a period in which a charged service will be utilized (called a “period of use”), and a location in which a charged service will be utilized (called a “location of use”). If a provider providing a charged service conducts billing such that a service fee varies by such variable information, a correlation between such variable information and the distribution ratio may be provided, as in the above-described types of variable information. Then, users are encouraged to try to reduce a service fee, compared with a case in which the distribution of a service fee is not calculated on the basis of variable information. For example, a provider changes a service fee by using variable information as follows: a service fee is less expensive, for example: if a service is more frequently used; during a campaign period or a specific time zone (for example, during the night) than other periods or other time zones; or in a specific location (a certain chain corner store) than other locations.

### [3] Modified Examples

The above-described exemplary embodiments are only examples to carry out the invention, and may be modified as follows. Additionally, the above-described exemplary embodiments and the following modified examples may be combined if necessary.

### [3-1] Output Device

In the above-described exemplary embodiments, the output device 20 outputs result data onto a medium, such as a sheet. However, the output device 20 may output result data to a display unit. In this case, the output device 20 does not have to have a function of forming images, and another device, such as a smartphone or a personal computer (PC), may be used as an output device. In this case, step S11 (input of identification information and selection of a charged service) and step S25 (displaying of selection results and calculation results) shown in FIG. 6, and step S61 and step S74 (displaying of distributed prices) shown in FIG. 13 are also executed in such an output device.

### [3-2] Calculation Based on Output Method

The calculator 103 may calculate distributed prices on the basis of the output method for result data. For example, the calculator 103 may change distributed prices depending on whether the output destination is a medium or a display unit. More specifically, if the output destination is a display unit, the calculator 103 may calculate distributed prices so that a total price will be equally distributed among users. If the output destination is a medium, the calculator 103 may calculate distributed prices so that the distributed price for a user who has operated an output device and received a medium will be larger or smaller than the distributed prices for the other users.

[3-3] Sharing Fee with another Entity as well as Users

In the above-described exemplary embodiments, the calculator 103 calculates distributed prices, assuming that a service fee is distributed among multiple users who have utilized a charged service. Alternatively, the calculator 103 may calculate distributed prices, assuming that a service fee is distributed among users utilized a charged service and another entity. Another entity is, for example, a provider a providing charged services or distributed billing services. It is assumed, for example, that the provider a providing distributed billing services charges for the outputting of result data onto a medium by using the output device 20 (for example, ¥10 per sheet), as well as for a service. In this case, the obtaining unit 102 obtains information concerning the number of mediums (for example, the number of sheets) as fee information, assuming that a fee for outputting result data onto a medium (called an “output fee”) is included in a service fee. In this case, the calculator 103 calculates distributed prices, assuming that a total fee of a fee charged by the provider a and an output fee is a service fee and that such a service fee is distributed among users who have utilized the service and the provider a. In this case, the calculator 103 calculates, for example, half the output fee as the distributed price for the provider a.

If the provider a is a manufacturer or a seller of the output device 20 even if it does not charge for an output fee, the calculator 103 may allocate a service fee to the provider a as an entity other than users. That is, as long as a charged service involves outputting result data to a medium, the calculator 103 may calculate distributed prices, assuming that a service fee is distributed among multiple users and also a provider which is involved in manufacturing or sales of a device that outputs result data onto a medium or which is involved in charging for the outputting of result data onto a medium. With this arrangement, if a user uses an output device related to the provider a, the distributed price for the user will become smaller than a case in which the user uses another output device. Thus, users are encouraged to use an output device related to such a provider.

When calculating distributed prices by using distribution ratios, as in the second exemplary embodiment, the calculator 103 may calculate distributed prices based on whether a provider a providing distributed billing services is involved in manufacturing or sales of a device which is used by a receiver to outputs result data or is involved in charging for outputting result data. In this case, if the provider a is involved, the distribution ratio for the provider a is set to be greater than a case in which the provider a is not involved. Then, the output device related to the provider a is more likely to be used than a case in which a service fee is not shared with the provider a. Additionally, even if a charged service does not involve outputting of result data to a medium, a service fee may be shared with a provider providing such a charged service. Then, this service is more likely to be used than a case in which a service fee is distributed only among users who have utilized this service.

### [3-4] Overpay Adjustment

In the second exemplary embodiment, as discussed above, there may be a case in which distributed prices are calculated on the basis of assumed variable information, such as a default value or a past actual value. In this case, when a charged service is actually utilized, actual variable information may become different from such assumed variable information, and as a result, a requester may overpay a distributed price. In this case, an overpaid amount may be adjusted when a distributed price is charged to a receiver. For example, when a receiver logs in to the system by using its identification information and performs an operation for outputting result data, variable information, such as the storage period, the CPU load, or the storage space for providing a charged service, has been determined. Accordingly, the calculator 103 recalculates the distributed prices on the basis of the determined variable information. It is now assumed that, in the example shown in FIG. 12, the distributed price for the requester (user U1) concerning the OCR service is not ¥15, but ¥10. Then, the output unit 104 outputs distributed price data indicating the original distributed price displayed for the requester and a new distributed price to the output device 20.

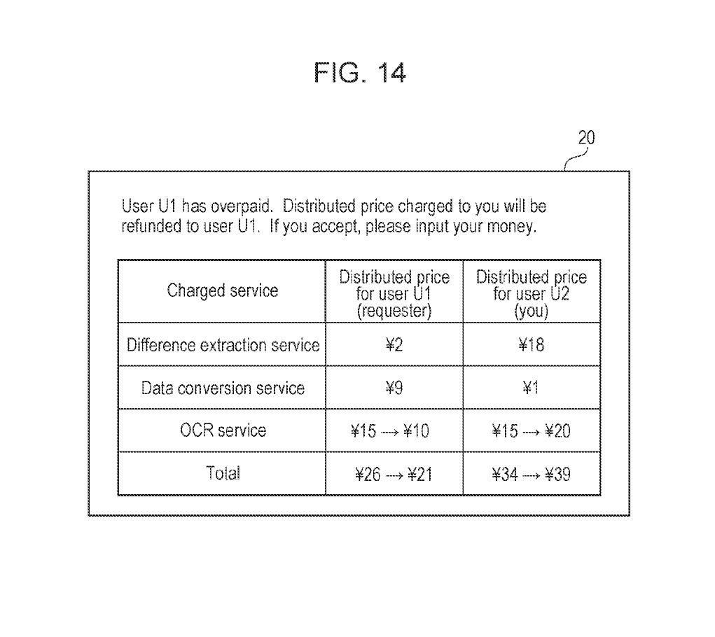

FIG. 14 illustrates an example of the distributed prices displayed on the output device 20. The output device 20 displays changes in the distributed prices shown in FIG. 12, such as “distributed price for user U1 (requester)” concerning the OCR service is changed from ¥15 to ¥10 and the total price is accordingly changed from ¥26 to ¥21, and “distributed price for user U2 (you)” concerning the OCR service is changed from ¥15 to ¥20 and the total price is accordingly changed from ¥34 to ¥39. The output device 20 also displays a character string indicating that part of the distributed price for the user U2 will be refunded to the user U1 for the overpaid amount. If the receiver accepts that the distributed price for the user U2 will be refunded to the user U1 and inputs money into a money storage box according to the distributed price, the output device 20 supplies this information to the information processing apparatus 10. The information processing apparatus 10 then outputs refund data indicating a refund amount, the identification information of a receiver (user U2) paying this refund, and the identification information of a requester (user U1) receiving this refund to, for example, the above-described transfer system. Then, the transfer system transfers the refund amount to the requester (user U1). Alternatively, when the users U1 and U2 use a charged service and share a service fee next time, the information processing apparatus 10 may calculate a distributed price for the user U1 by deducting this refund amount.

### [3-5] Distribution Based on Expected Points

The calculator 103 may calculate distributed prices on the basis of expected points used for selecting identification information discussed in the first exemplary embodiment. For example, when distributing a service fee (for example, ¥300) among users U1, U2, and U3, if expected points of the users U1, U2, and U3 are 100, 50, and 0, respectively, the calculator 103 calculates distributed prices at a ratio of 11:10:9 in descending order of expected points. As a result, the distributed prices for the users U1, U2, and U3 are calculated as ¥110, ¥100, and ¥90, respectively. A user who will obtain greater expected points has more benefits by paying for a service fee. Accordingly, even if the distributed price for such a user is larger than those of the other users, such a user is likely to be persuaded. With this arrangement, by calculating distributed prices on the basis of expected points in the above-described manner, users are more likely to be persuaded, compared with a case in which distributed prices are calculated without considering expected points.

### [3-6] Distribution Based on Solvency

The calculator 103 may calculate distributed prices on the basis of the solvency of each user. Solvency is determined by, for example, a credit limit of a credit card or the balance of electronic money or a bank account. If the credit limit of a credit card, for example, has been registered by a user, the calculator 103 sets a greater distributed price as the credit limit is greater since the solvency of this user is larger. If there is a mechanism for obtaining information concerning the balance of electronic money or a bank account, the calculator 103 calculates distributed prices on the basis of the balance. If the distributed price for a certain user is higher than the balance of this user, the calculator 103 may decrease the distributed price to the amount of balance and may add a shortfall to the distributed price for another user. The calculator 103 may set the distributed price to be higher for a user having a larger balance. With this arrangement, the distributed prices are more likely to be paid, compared with a case in which distributed prices are not calculated on the basis of the solvency.

### [3-7] Distribution Based on Other Information

The calculator 103 may calculate distributed prices at a distribution ratio which is determined for users (for example, 1:2:3 for users U1, U2, and U3) in advance. The calculator 103 may calculate distributed prices on the basis of the billing methods used by users. For example, the distribution ratio, for example, 1:2:3:4, may be determined for flat-rate billing, fixed-volume flat-rate billing, price-cap billing, and measured-rate billing. If the billing methods utilized by the users U1, U2, and U3 for a certain charged service are flat-rate billing, fixed-volume flat-rate billing, and measured-rate billing, respectively, the calculator 103 calculates distributed prices at a distribution ratio of 1:2:4 for a service fee. In this example, a distributed price for a user using flat-rate billing is set to be smaller than those for other users in order to reduce the load on this user since this user has already paid a fixed amount of fee.

### [3-8] Selection of Different Items of Identification Information

In the first exemplary embodiment, the selector 101 selects only one item of identification information for a certain charged service. However, the selector 101 may change identification information to be selected every time a service is used if the service is used more than one time. More specifically, if a certain service is used seven times, the selector 101 selects identification information of the user U1 for the first to third times, and then selects identification information of the user U2 for the fourth to seventh times. This is beneficial to all users, for example, for the following case. A service fee becomes less expensive if the identification information of the user U1 is used up to the third time since the user U1 uses fixed-volume flat-rate billing. However, from the fourth time, measured-rate billing is used for the user U1 in excess of a certain volume, and thus, a service fee becomes less expensive if the identification information of the user U2 is used.

### [3-9] Provision of Mail-Order or Telephone-Order Services

In the information processing system 1, the provision of goods by mail-order or telephone-order services as charged services may be performed. In this case, distributed prices are calculated, assuming that the cost of goods to be purchased is distributed among multiple users.

### [3-10] Categories of the Invention

The present invention may be implemented as, as well as an information processing apparatus and an information processing system including the information processing apparatus, as an information processing method for realizing processing performed by an apparatus, such as the information processing apparatus. In this case, the processing performed by the information processing apparatus is, for example, distributed billing processing shown in FIG. 6. The invention is also implemented as a program for causing a computer, such as the information processing apparatus, to function as means, such as the units shown in FIG. 3. This program may be provided in the form of a recording medium, such as an optical disc, by recording the program on the recording medium. The program may be downloaded by using a computer via a network, such as the Internet, and be installed into the computer.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
an obtaining unit that obtains fee information indicating a fee of a service used by a plurality of users;
a calculator that calculates a distributed price to be charged to each of the plurality of users if the fee indicated by the fee information obtained by the obtaining unit is distributed among the plurality of users; and
an output unit that outputs data indicating distributed prices calculated by the calculator and items of identification information for identifying the plurality of users to which the distributed prices are charged.

2. The information processing apparatus according to claim 1, further comprising:
a selector that selects, if billing methods for the fee are determined in association with the plurality of items of identification information for identifying the plurality of users, one of the plurality of items of identification information on the basis of benefit information indicating whether or not each of the plurality of users will benefit,
wherein the obtaining unit obtains, as the fee information, information indicating a fee to be charged by using a billing method which is determined in association with an item of identification information selected by the selector.

3. The information processing apparatus according to claim 2, wherein the selector selects one of the plurality of items of identification information, by utilizing, as the benefit information, information indicating a fee to be charged assuming that each of the billing methods is utilized, points which will be expected to be obtained if points are provided by paying for the fee, a period in which the service will be used, a location in which the service will be used, or the content of the service.

4. The information processing apparatus according to claim 2, wherein the calculator calculates distributed prices on the basis of whether or not each of the plurality of users is a user identified by the item of identification information selected by the selector or how much the fee has become less expensive by selecting the item of identification information than a fee if another item of identification information is selected.

5. The information processing apparatus according to claim 1, wherein the calculator calculates distributed prices on the basis of variable information that is possible to vary the fee of the service.

6. The information processing apparatus according to claim 5, wherein the calculator calculates distributed prices by utilizing, as the variable information, the number of times the service is used, the frequency with which the service is used, a period in which the service is used, a location in which the service is used, a time taken to use the service, a load of a central processing unit imposed by performing processing concerning the service, or a storage space to be secured for performing the processing.

7. The information processing apparatus according to claim 1, wherein the calculator calculates distributed prices to be charged if the fee of the service is distributed among the plurality of users and an entity other than the plurality of users.

8. The information processing apparatus according to claim 7, wherein, if the service involves outputting to a medium, the calculator calculates distributed prices by assuming, as an entity other than the plurality of users, a provider which is involved in manufacturing or sales of a device that performs outputting to a medium or which is involved in charging for outputting to a medium.

9. The information processing apparatus according to claim 1, wherein the calculator calculates distributed prices on the basis of points which will be expected to be obtained if points are provided by paying for the fee.

10. The information processing apparatus according to claim 1, wherein the calculator calculates distributed prices on the basis of solvency of each of the plurality of users.

11. An information processing method comprising:
obtaining fee information indicating a fee of a service used by a plurality of users;
calculating a distributed price to be charged to each of the plurality of users if the fee indicated by the obtained fee information is distributed among the plurality of users; and
outputting data indicating calculated distributed prices and items of identification information for identifying the plurality of users to which the distributed prices are charged.

12. A non-transitory computer readable medium storing a program causing a computer to execute a process, the process comprising:
obtaining fee information indicating a fee of a service used by a plurality of users;
calculating a distributed price to be charged to each of the plurality of users if the fee indicated by the obtained fee information is distributed among the plurality of users; and
outputting data indicating calculated distributed prices and items of identification information for identifying the plurality of users to which the distributed prices are charged.
